(19) United States
(12) Patent Application Publication
(10) Pub. No.: US 2025/0263042 A1
(43) Pub. Date: Aug. 21, 2025

(54) NOTIFICATION DEVICE, NOTIFICATION METHOD, AND RECORDING MEDIUM

(71) Applicant: Panasonic Automotive Systems Co., Ltd., Kanagawa (JP)

(72) Inventors: Takuma IIDA, Kanagawa (JP); Seina NAKAMURA, Tokyo (JP); Tomoya NAGATA, Saitama (JP); Eiyoshi NAKATSUJI, Kanagawa (JP); Masayoshi OHTANI, Kanagawa (JP); Katsuyuki ITOU, Kanagawa (JP); Kaoru YOKOTA, Hyogo (JP)

(73) Assignee: Panasonic Automotive Systems Co., Ltd., Kanagawa (JP)

(21) Appl. No.: 19/049,702

(22) Filed: Feb. 10, 2025

(30) Foreign Application Priority Data
Feb. 15, 2024 (JP) 2024-021516

(51) Int. Cl. B60R 25/10; B60W 40/08; G06F 21/55

(52) U.S. Cl. CPC B60R 25/10; B60W 40/08; G06F 21/554

(57) ABSTRACT

A notification device includes: an intrusion depth obtainer that obtains the intrusion depth of a cyber attack on a moving body (vehicle); a passenger state obtainer that obtains the passenger state of a passenger in the moving body; a mode determiner (passenger notification mediator) that determines a notification mode based on the obtained intrusion depth and the obtained passenger state; and a notification controller that causes a security notification to be output, where the security notification is for notifying, in accordance with the determined notification mode, the passenger that the cyber attack was made.

### CROSS REFERENCE TO RELATED APPLICATION

The present application is based on and claims priority of Japanese Patent Application No. 2024-021516 filed on Feb. 15, 2024.

### FIELD

The present disclosure relates to a notification device, a notification method, and a recording medium.

### BACKGROUND

In recent years, the technologies of autonomous movement (autonomous driving) have been improved and are being put into practical use for moving bodies such as vehicles. For example, PTL 1 discloses a technique pertaining to a vehicle or the like that is capable of switching between an automatic driving (autonomous driving) mode and a manual driving mode.

### CITATION LIST

### Patent Literature

PTL 1: WO 2017/085981

### SUMMARY

However, the conventional techniques disclosed in PTL 1 can be improved upon. In view of the above, the present disclosure aims to provide a notification device and others capable of improving upon the above related art.

A notification device according to one aspect of the present disclosure includes: an intrusion depth obtainer that obtains the intrusion depth of a cyber attack on a moving body; a passenger state obtainer that obtains the passenger state of a passenger in the moving body; a mode determiner that determines a notification mode based on the intrusion depth obtained and the passenger state obtained; and a notification controller that causes a security notification to be output, where the security notification is for notifying, in accordance with the notification mode determined, the passenger that the cyber attack was made.

A notification method according to one aspect of the present disclosure is a notification method to be executed by a computer, and includes: obtaining the intrusion depth of a cyber attack on a moving body; obtaining the passenger state of a passenger in the moving body; determining a notification mode based on the intrusion depth obtained and the passenger state obtained; and causing a security notification to be output, where the security notification is for notifying, in accordance with the notification mode determined, the passenger that the cyber attack was made.

A recording medium according to one aspect of the present disclosure is a non-transitory computer-readable recording medium for use in a computer, the recording medium having recorded thereon a computer program for causing the computer to execute the notification method described above.

Note that these general or specific aspects of the present disclosure may be realized by a device, an integrated circuit, a computer program, a computer-readable non-transitory recording medium such as a CD-ROM, or any combination thereof.

The notification device and the like according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating one example of the functional configuration of a vehicle including a notification device according to an embodiment.

FIG. 2 is a conceptual diagram illustrating an example of an intrusion in a cyber attack according to the embodiment.

FIG. 3 is a diagram illustrating an example of the determination of passenger states according to the embodiment.

FIG. 4 is a diagram illustrating one example of information used for the determination of a vehicle state according to the embodiment.

FIG. 5 is a diagram illustrating one example of information for identifying notification means provided in a vehicle according to the embodiment.

FIG. 6 is a flowchart illustrating one example of the operation of a vehicle including the notification device according to the embodiment.

FIG. 7 is a diagram illustrating one example of determining a notification mode according to the embodiment.

FIG. 8 is a diagram illustrating another example of determining a notification mode according to the embodiment.

FIG. 9 is a diagram for describing the notification ranks of passengers according to Variation 1 of the embodiment.

FIG. 10 is a diagram for describing the notification ranks of passengers according to Variation 1 of the embodiment.

FIG. 11 is a diagram for describing the use mode of passengers according to Variation 2 of the embodiment.

FIG. 12 is a diagram for describing the use mode of passengers according to Variation 2 of the embodiment.

FIG. 13 is a diagram for describing the use mode of a passenger according to Variation 2 of the embodiment.

FIG. 14 is a diagram illustrating one example of determining a notification mode in each use mode according to Variation 2 of the embodiment.

FIG. 15 is a diagram illustrating another example of determining a notification mode in each use mode according to Variation 2 of the embodiment.

### DESCRIPTION OF EMBODIMENTS

### Outline of the Present Disclosure

An overview of the present disclosure is as follows.

The present inventors found that, in relation to the technique described in the section “Background”, moving bodies have recently become targets of cyber attacks, and such cyber attacks need to be addressed. Hence, the present disclosure provides a notification device and the like for more appropriately notifying a passenger that a cyber attack has been made, as an advanced improvement.

A notification device according to a first aspect of the present disclosure includes: an intrusion depth obtainer that obtains the intrusion depth of a cyber attack on a moving body; a passenger state obtainer that obtains the passenger state of a passenger in the moving body; a mode determiner that determines a notification mode based on the intrusion depth obtained and the passenger state obtained; and a notification controller that causes a security notification to be output, where the security notification is for notifying, in accordance with the notification mode determined, the passenger that the cyber attack was made.

With such a notification device, it is possible to notify the passenger that the cyber attack was made in a notification mode with consideration given to the intrusion depth of the cyber attack and the passenger state of the passenger. That is, it becomes possible to more appropriately notify the passenger that the cyber attack was made from the viewpoint of the intrusion depth of the cyber attack and the passenger state of the passenger.

A notification device according to a second aspect of the present disclosure is the notification device according to the first aspect, and the mode determiner causes the security notification to be output at timing when the intrusion depth reaches a predetermined depth.

Accordingly, it is possible to send a notification in a notification mode in which the security notification is caused to be output at the timing when the intrusion depth reaches the predetermined depth.

A notification device according to a third aspect of the present disclosure is the notification device according to the first or second aspect. The mode determiner selects a notification means according to the passenger state from among a plurality of candidates for the notification means, and causes the notification means selected to output the security notification.

Accordingly, it is possible to send a notification in a notification mode in which the security notification is caused to be output with the notification means selected according to the passenger state from among the plurality of candidates for the notification means.

A notification device according to a fourth aspect of the present disclosure is the notification device according to any one of the first to third aspects, and further includes a moving body state obtainer that obtains the moving body state of the moving body. The mode determiner determines the notification mode based also on the moving body state obtained.

Accordingly, it is possible to send a notification in a notification mode determined based also on the moving body state obtained.

A notification device according to a fifth aspect of the present disclosure is the notification device according to the fourth aspect, and the moving body state includes at least one of whether the moving body is activated, a movement speed of the moving body, or whether the moving body is in an autonomous movement mode.

Accordingly, it is possible to send a notification in a notification mode determined based also on the moving body state including at least one of whether the movable body is activated, the movement speed of the moving body, and whether the moving body is in the autonomous movement mode.

A notification device according to a sixth aspect of the present disclosure is the notification device according to the fourth or fifth aspect. The moving body state includes a use mode of the passenger who is using the moving body. The mode determiner determines the notification mode under a rule that is different depending on the use mode.

Accordingly, it is possible to send a notification in a notification mode determined based also on the moving body state including the use mode of the passenger who is using the moving body.

A notification device according to a seventh aspect of the present disclosure is the notification device according to any one of the fourth to sixth aspects. The moving body state includes the configuration of a notification means provided in the moving body. The mode determiner determines, for each of notification means provided in the moving body, a notification order according to the passenger state, and causes each of the notification means to output the security notification in the notification order determined, where each of the notification means is the notification means.

Accordingly, it is possible to send a notification in a notification mode in which, for each of notification means provided in the moving body, the notification order is determined according to the passenger state, and each of the notification means is caused to output the security notification in the notification order determined, based also on the moving body state including the configuration of the notification means provided in the moving body.

A notification device according to an eighth aspect of the present disclosure is the notification device according to any one of the first to seventh aspects. One or more passengers are in the moving body, where each of the one or more passengers is the passenger. The notification mode includes specifying a target passenger to be notified among the one or more passengers, where the target passenger is based on the passenger state. The notification controller causes the security notification to be output, where the security notification notifies the target passenger and does not notify remaining passengers excluding the target passenger that the cyber attack was made.

Accordingly, it is possible to send a notification in a notification mode in which a target passenger to be notified is specified from among one or more passengers, and a security notification in which the target passenger is notified that the cyber attack was made, and the remaining passengers excluding the target passenger are not notified that the cyber attack was made is caused to be output.

A notification method according to a ninth aspect of the present disclosure is a notification method to be executed by a computer, and includes: obtaining the intrusion depth of a cyber attack on a moving body; obtaining the passenger state of a passenger in the moving body; determining a notification mode based on the intrusion depth obtained and the passenger state obtained; and causing a security notification to be output, where the security notification is for notifying, in accordance with the notification mode determined, the passenger that the cyber attack was made.

Accordingly, it is possible to provide the same advantageous effects as with the notification device described above.

A recording medium according to a tenth aspect of the present disclosure is a non-transitory computer-readable recording medium for use in a computer, the recording medium having recorded thereon a computer program for causing the computer to execute the notification method according to the ninth aspect.

Accordingly, by causing the computer to execute the program, it is possible to provide the same advantageous effects as with the notification method described above.

Note that these general or specific aspects of the present disclosure may be realized by a device, an integrated circuit, a computer program, a computer-readable non-transitory recording medium such as a CD-ROM, or any combination thereof.

Hereinafter, embodiments will be described in detail with reference to the drawings where necessary. However, unnecessarily detailed description may be omitted. For example, detailed description of matters that are already well-known and duplicate description of substantially same elements may be omitted. This aims to avoid unnecessarily redundant descriptions and make the following description easy for persons skilled in the art to understand.

Note that the inventors of the present application provide the following description and attached drawings for persons skilled in the art to fully understand the present disclosure, and the description and the drawings are not intended to limit the subject matters recited in the claims.

### Embodiment

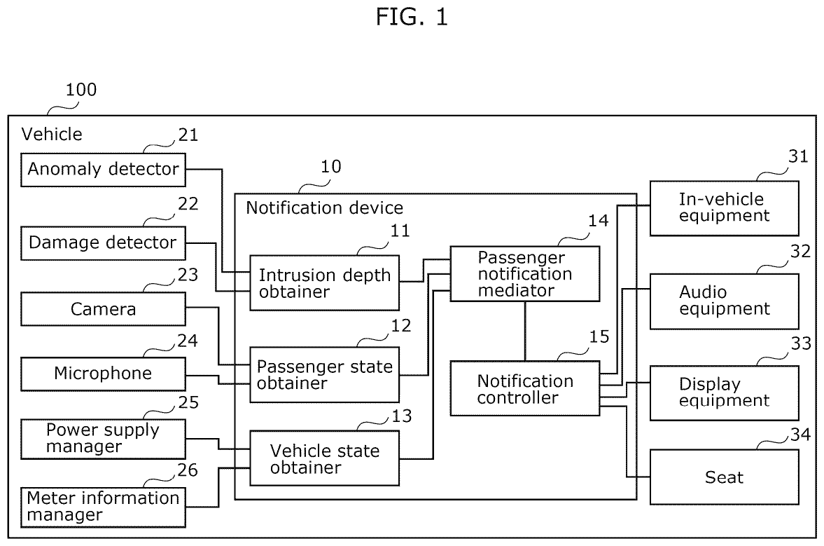

FIG. 1 is a block diagram illustrating one example of the functional configuration of a vehicle including a notification device according to an embodiment. In the present embodiment, a vehicle will be exemplarily described as one example of a moving body. However, the moving body is not limited to a vehicle. An object other than a vehicle such as a watercraft or an aircraft to which technical details disclosed in the present application are applicable can be assumed to be the moving body.

As illustrated in FIG. 1, vehicle 100 includes notification device 10. Notification device 10 is implemented with a computer or the like provided in vehicle 100. More specifically, notification device 10 is implemented with a processor and a memory provided in vehicle 100 by executing a program pertaining to notification device 10 stored in the memory. Notification device 10 obtains information from another device of vehicle 100 and outputs a security notification for notifying another device placed in vehicle 100. That is, notification device 10 receives and outputs information with other devices of vehicle 100. Therefore, if information can be received and output between vehicle 100 and other devices, it is possible to implement the same configuration without providing notification device 10 in vehicle 100. For example, notification device 10 may be built in a cloud server that can receive and output information from and to other devices of vehicle 100 through a network such as the Internet. Alternatively, only a configuration in notification device 10 that particularly bears a high processing load may be disposed in a cloud server, and the configuration in the cloud server and a configuration that is disposed in vehicle 100 and bears a relatively low processing load may be combined together to implement notification device 10.

As illustrated in FIG. 1, vehicle 100 includes anomaly detector 21, damage detector 22, camera 23, microphone 24, power supply manager 25, meter information manager 26, in-vehicle equipment 31, audio equipment 32, display equipment 33, seats 34, and notification device 10. Of these, anomaly detector 21, damage detector 22, camera 23, microphone 24, power supply manager 25, and meter information manager 26 are devices that input information into notification device 10. In-vehicle equipment 31, audio equipment 32, display equipment 33, and seats 34 are devices that notify a passenger in vehicle 100 with a security notification output from notification device 10. To be exact, in-vehicle equipment 31 is however not included in vehicle 100. In-vehicle equipment 31 is an information terminal for notifying the passenger in the inner space of vehicle 100. Notification device 10 includes intrusion depth obtainer 11, passenger state obtainer 12, vehicle state obtainer 13, passenger notification mediator 14, and notification controller 15.

Anomaly detector 21 is an information processor that detects an anomaly caused by a cyber attack in the devices provided in vehicle 100 (also referred to as in-vehicle devices) or in an in-vehicle network that communicably connects these devices together. For example, anomaly detector 21 may be included in an in-vehicle device and monitor the in-vehicle device to detect an anomaly in the in-vehicle device. Alternatively, anomaly detector 21 may monitor an in-vehicle device over the network to detect an anomaly in the in-vehicle device. Anomaly detector 21 may monitor the in-vehicle network, rather than an in-vehicle device, to detect an anomaly in the in-vehicle network.

For example, anomaly detector 21 may detect an anomaly in an in-vehicle device or the in-vehicle network in accordance with a log or the like of the in-vehicle device or the in-vehicle network.

Damage detector 22 is an information processor that detects damage to vehicle 100, an in-vehicle device, or the in-vehicle network. For example, damage detector 22 detects a state where an operation is not performed properly. Damage detector 22 may detect an abnormal operation, a stopped operation, a reduced reaction, an excessive reaction, or the like of vehicle 100, an in-vehicle device or the in-vehicle network. The detection performed by anomaly detector 21 and the detection performed by damage detector 22 may overlap each other. The “anomaly” may include the “damage”, or the “damage” may include the “anomaly”.

For example, damage detector 22 may detect damage to vehicle 100, an in-vehicle device, or the in-vehicle network in accordance with a log or the like of the in-vehicle device or the in-vehicle network. In the present embodiment, damage is treated as being the same as an anomaly, as a type of an anomaly. However, damage and an anomaly may be treated as being different from each other.

An anomaly detected by anomaly detector 21 and damage detected by damage detector 22 (hereinafter, collectively referred to as an anomaly detection result) are used for the determination as to whether an unauthorized cyber attack has been made. For example, the anomaly detection result is received, and the received anomaly detection result is stored in a storage or the like. A plurality of anomaly detection results that are close in detection time point to the received anomaly detection result are then extracted from the storage. The plurality of extracted anomaly detection results are then sorted in order of detection time point. Whether the plurality of sorted anomaly detection results follow a predetermined order of attack is then determined. If the plurality of sorted anomaly detection results follow the predetermined order of attack, it is determined that these anomaly detection results correspond to an unauthorized cyber attack. That is, it is determined that the unauthorized cyber attack has been made. Then, in accordance with the plurality of anomaly detection results and the predetermined order of attack, the intrusion route and the intrusion depth of this cyber attack are identified. If the plurality of sorted anomaly detection results do not follow the predetermined order of attack, it is determined that these anomaly detection results do not correspond to an unauthorized cyber attack. That is, it is determined that the unauthorized cyber attack has not been made. Information about the predetermined order of attack is set in advance based on a log of a past unauthorized cyber attack and is stored in the storage or the like.

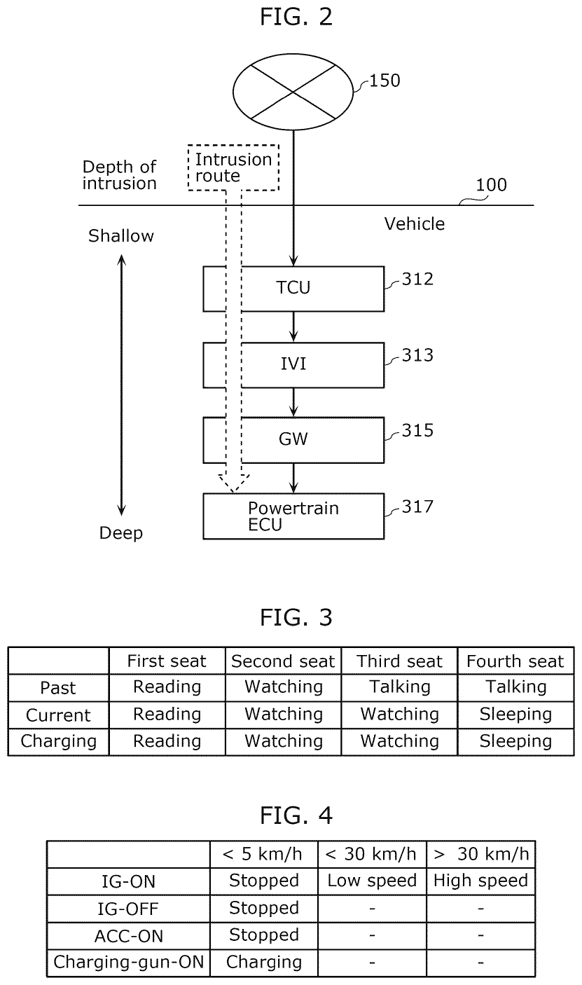

FIG. 2 is a conceptual diagram illustrating an example of an intrusion in a cyber attack according to the embodiment. For example, it is assumed that an attack is made on vehicle 100 from network 150 in order of TCU 312, IVI 313, GW 315, and powertrain ECU 317. At this time, the intrusion depth increases in order of TCU 312, IVI 313, GW 315, and powertrain ECU 317. As the intrusion depth increases, an impact on the use of vehicle 100 increases. Conversely, there is such a minor cyber attack in which an anomaly is detected only in TCU 312 and IVI 313. Such a minor cyber attack has a small impact on the use of vehicle 100. If the notifications of all types of cyber attacks are sent to a passenger, the notifications would include those of even minor cyber attacks which have little impact on the use of vehicle 100, which is cumbersome. Hence, in the present embodiment, a threshold value pertaining to the degree of the intrusion depth of a cyber attack (a predetermined depth) is provided, and at timing when the intrusion depth reaches the predetermined depth, a passenger is notified that a cyber attack has been made. That is, in the present embodiment, a notification mode (here, whether to send a notification, that is, timing for sending a notification) is determined, and in accordance with the determined mode, a notification that a cyber attack has been made is sent to a passenger. The determination of a notification mode can be regarded as the mediation of a notification to a passenger.

Note that the above describes one example of the intrusion depth of one intrusion route. The intrusion depth corresponds to any one of depths that are set in accordance with the number of constituent elements passed through from an intrusion point or are set to the constituent elements individually.

In the present embodiment, intrusion depth obtainer 11 identifies the intrusion depth by obtaining an anomaly detection result of the detections by anomaly detector 21 and damage detector 22 and performing the above-described determination and the like. That is, intrusion depth obtainer 11 obtains the intrusion depth identified by itself. Alternatively, intrusion depth obtainer 11 may only simply obtain an intrusion depth identified by another component.

Camera 23 is an imaging device provided in vehicle 100 and is configured to image a passenger in vehicle 100. As a result, camera 23 can generate image data on the passenger obtained by imaging the passenger in vehicle 100.

Microphone 24 is a sound collecting device provided in vehicle 100 and is configured to collect a voice of a passenger in vehicle 100. As a result, microphone 24 can generate voice data on the passenger obtained by collecting a voice of the passenger in vehicle 100.

The image data generated by camera 23 and the voice data generated by microphone 24 are used for the determination of a passenger state. Specifically, the generated image data and voice data are subjected to data processing to be synchronized to each other in a time-series manner, and thus data including images and voices that are arranged in one time series is generated. By personal authentication using this data, a passenger can be distinguished from another passenger or other passengers. The usage of the result of the personal identification will be described later. For each passenger, image data and voice data on the passenger are input into a trained AI model. The trained AI model has been trained with a dataset including a large amount of image data and voice data and including labeled data on passenger states corresponding to the image data and the voice data. In response to input image data and voice data, the trained AI model outputs a corresponding passenger state by inference. As a result, it is possible to obtain a passenger state corresponding to image data and voice data on each passenger. FIG. 3 is a diagram illustrating an example of the determination of passenger states according to the embodiment. FIG. 3 illustrates, for four seats provided in vehicle 100, a first seat to a fourth seat, the results of determining the states of passengers (any one of “sleeping”, “reading”, “talking”, “watching”) continuously from a past time until a current time. Note that in the case of “charging” for vehicle 100 being an electric vehicle (or refueling for vehicle 100 being an internal combustion vehicle), the states of the passengers often differ from those in other cases and are thus recorded separately from the cases other than charging. Note that “sleeping” indicates a situation in which a passenger is sleeping, leaving the movement of vehicle 100 to autonomous movement, “reading” indicates a situation in which a passenger is reading something, “talking” indicates a situation in which a passenger is talking with another person, and “watching” indicates a situation in which a passenger is watching some content.

In the present embodiment, passenger state obtainer 12 obtains image data and voice data, performs the above-described processing, and outputs the passenger states. That is, passenger state obtainer 12 obtains the passenger states output by itself. Alternatively, passenger state obtainer 12 may only simply obtain passenger states output by another component.

Power supply manager 25 is a functional unit that manages the conduction of electric power in vehicle 100. Power supply manager 25 can generate information on an activation-and-power-supply state of vehicle 100 indicating, for example, which of an IG-ON state, an IG-OFF state, an ACC-ON state, and a charging-gun-ON state vehicle 100 is in.

Meter information manager 26 is a functional unit that manages meters such as a meter of a movement speed (travelling speed) of vehicle 100. For example, meter information manager 26 can generate information on a movement speed indicating the current traveling speed of vehicle 100 in kilometers per hour (km/h).

The information on the activation-and-power-supply state of vehicle 100 and the information on the movement speed of vehicle 100 are used for the determination of a vehicle state. For example, vehicle states corresponding to movement speeds in the IG-ON state are determined in advance, vehicle states corresponding to movement speeds in the IG-OFF state are determined in advance, vehicle states corresponding to movement speeds in the ACC-ON state are determined in advance, vehicle states corresponding to movement speeds in the charging-gun-ON state are determined in advance, and the vehicle states are summarized in a table or the like that shows the correlation between the information on the activation-and-power-supply state and the information on the movement speed. FIG. 4 is a diagram illustrating one example of information used for the determination of the vehicle state according to the embodiment. FIG. 4 illustrates one example of the table showing the above-described correlation.

In the present embodiment, vehicle state obtainer 13 obtains the information on the activation-and-power-supply state of vehicle 100 and the information on the movement speed of vehicle 100 and determines the vehicle state using the above-described table. That is, vehicle state obtainer 13 obtains the vehicle state determined by itself. Alternatively, vehicle state obtainer 13 may only simply obtain a vehicle state determined by another component. Note that, in addition to the above, whether the autonomous driving of vehicle 100 is ON or OFF may be included as one of the vehicle states.

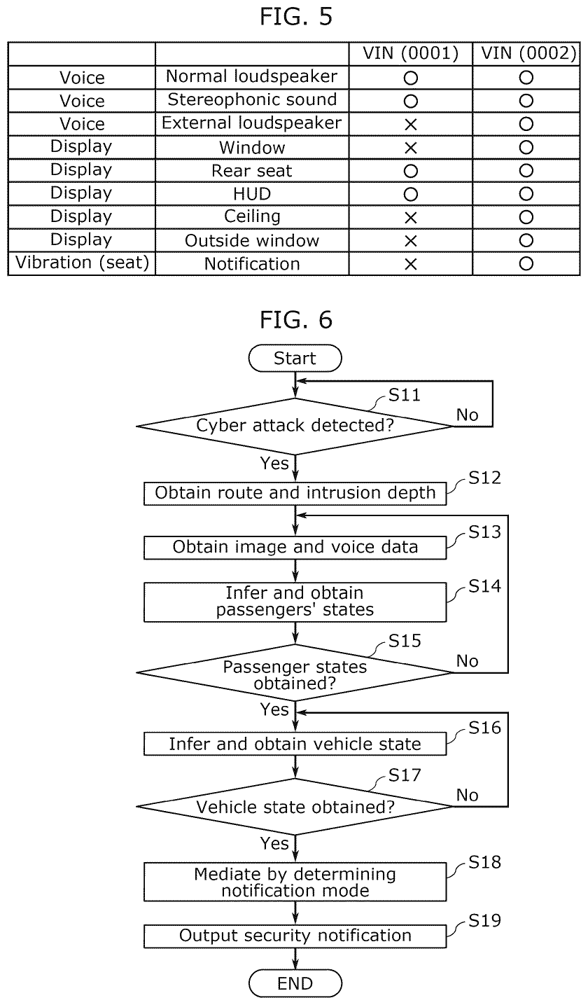

In the present embodiment, each of the devices provided in vehicle 100 that notify a passenger constitutes one notification means. That is, vehicle 100 illustrated in FIG. 1 is provided with four notification means. In contrast, a vehicle different from vehicle 100 is to be provided with a different number of notification means. In the present embodiment, which of the notification means is to be used for the determination of the notification mode is determined as one of notification modes. Therefore, notification device 10 needs to grasp what notification means are provided in vehicle 100. In the present embodiment, information indicating what notification means are provided is included as one of vehicle states. Specifically, vehicle state obtainer 13 obtains VIN information on vehicle 100. Then, by referring to a table illustrated in FIG. 5 using the obtained VIN information, information indicating what notification means are provided in vehicle 100 can be obtained. FIG. 5 is a diagram illustrating one example of information for identifying notification means provided in the vehicle according to the embodiment. In the figure, whether each of devices pertaining to some notification means is provided (with a circle in the figure) or not (with a cross in the figure) is shown for each of VIN(0001) and VIN(0002). The VIN information includes information on vehicle 100 including a manufacturer's serial number, specifications, equipment, and the like. Therefore, from the VIN information, the configuration of provided devices that notify a passenger can be identified.

Passenger notification mediator 14 is a processing unit that determines a notification mode to cause a security notification to be output in accordance with the determined notification mode. The determination of a notification mode can be regarded as the mediation of a notification to a passenger. Thus, it can be said that passenger notification mediator 14 is a processing unit that mediates in a notification to a passenger. Passenger notification mediator 14 determines the notification mode based on the obtained intrusion depth and passenger state, or an intrusion depth, a passenger state, and a vehicle state.

Notification controller 15 is a processing unit that outputs a security notification with which a passenger is notified in accordance with the determined notification mode. With the output security notification, notification controller 15 controls the operation of each device that notifies a passenger. In other words, each device that notifies a passenger can notify the passenger in accordance with the notification mode by only operating in accordance with the security notification output by notification controller 15.

In-vehicle equipment 31 is, for example, not a device built in vehicle 100 but an information terminal such as a PC, a smartphone, or a tablet terminal that is brought into the interior of vehicle 100. For a passenger using such an information terminal, notifying the passenger via the information terminal may be appropriate in some cases. Such an information terminal is included in one of the devices that notify a passenger in the present embodiment. In-vehicle equipment 31 is communicably connected to vehicle 100 directly or indirectly via an external server or the like. In-vehicle equipment 31 receives a security notification output from vehicle 100 and gives a passenger one or more types of stimuli such as a display (visual stimulus), a sound (auditory stimulus), and a vibration (tactile stimulus). In-vehicle equipment 31 includes a projector, a hologram generator, and an XR display providing VR/AR, etc., that perform only displaying using a video output function of vehicle 100.

Audio equipment 32 is a device capable of outputting a sound, such as a loudspeaker of what is called a car audio system. Audio equipment 32 receives a security notification output from vehicle 100 and gives a passenger a stimulus of the sound type (auditory stimulus).

Display equipment 33 is a device capable of outputting an image, such as a display screen included in an instrument panel or a meter panel, an ARHUD, a ceiling-projection display device, a rear-seat display device, or a window-superimposing display device. Display equipment 33 receives a security notification output from vehicle 100 and gives a passenger a stimulus of the display type (visual stimulus).

Seats 34 are seats on which passengers sit. Each of seats 34 includes a built-in vibration device. Receiving a security notification output from vehicle 100, each seat 34 causes its vibration device to operate, giving a passenger a stimulus of the vibration type (tactile stimulus).

Next, with reference to FIG. 6 to FIG. 8, the operations of notification device 10 and vehicle 100 configured as above will be described. FIG. 6 is a flowchart illustrating one example of the operation of the vehicle including the notification device according to the embodiment.

As illustrated in FIG. 6, at least one of anomaly detector 21 and damage detector 22 determines whether an anomaly has been detected (step S11). For example, this determination is performed by intrusion depth obtainer 11 based on whether an anomaly detection result has been generated by at least one of anomaly detector 21 and damage detector 22. If intrusion depth obtainer 11 determines that no anomaly has been detected (No in step S11), step S11 is repeated until an anomaly is detected. On the other hand, if intrusion depth obtainer 11 determines that an anomaly has been detected (Yes in step S11), the intrusion route and the intrusion depth of a cyber attack are determined about the anomaly, and the result of the determination is obtained (step S12). Meanwhile, passenger state obtainer 12 obtains image data and voice data (step S13). From the obtained image data and voice data, passenger state obtainer 12 then infers the passenger states of passengers and obtains the result of the inference (step S14). Passenger state obtainer 12 determines the result of the inference, that is, whether the passenger states have been successfully obtained (step S15). If passenger state obtainer 12 has failed to obtain the passenger states (No in step S15), passenger state obtainer 12 returns to step S13, obtains new image data and voice data, and repeats the same processing.

If the passenger states have been successfully obtained (Yes in step S15), vehicle state obtainer 13 additionally infers a vehicle state and obtains the result of the inference (step S16). Vehicle state obtainer 13 determines the result of the inference, that is, whether the vehicle state has been successfully obtained (step S17). If vehicle state obtainer 13 has failed to obtain the vehicle state (No in step S17), vehicle state obtainer 13 returns to step S16 and repeats the same processing. If the vehicle state has been successfully obtained (Yes in step S17), passenger notification mediator 14 mediates in notifications to the passengers by determining notification modes (step S18).

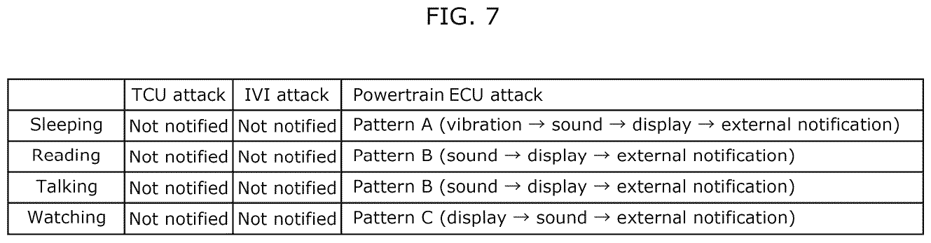

Here, FIG. 7 is a diagram illustrating one example of determining a notification mode according to the embodiment. As illustrated in FIG. 7, in the case of a minor cyber attack to the extent that its intrusion depth reaches TCU 312 and IVI 313, no notification is sent irrespective of a passenger state. In contrast, in the case of such a serious cyber attack that its intrusion depth reaches powertrain ECU 317, a notification is sent in different patterns. The patterns shown here are one example of notification orders (or also called notification patterns). Each pattern specifies a plurality of notification means and the order of the notification means. Note that there may be a notification means that is included in one pattern and not included in another pattern. That is, all of the notification means need not be included in each pattern.

As a specific example, in the case where a passenger state is “sleeping”, a notification is sent in pattern A (sequentially in the order of vibration→sound→display→external notification). Likewise, in the case where the passenger state is “reading” or “talking”, a notification is sent in pattern B (sequentially in the order of sound→display→external notification). Pattern A is different from pattern B in that a notification with a vibration for causing a sleeping passenger to wake up is added to pattern A.

In the case where the passenger state is “watching”, a notification is sent in pattern C (sequentially in the order of display→sound→external notification). Pattern C is different from pattern B in that the order of a notification with an interrupt display to content to a passenger watching the content and a notification with a sound is switched. Note that the external notification is a notification sent to the outside of vehicle 100. For example, the external notification includes a notification to the manufacturer of vehicle 100 or a warning notification to a vehicle around vehicle 100. The latter notification may be directly sent using an HMI or the like provided on the exterior of vehicle 100 or may be sent using a notification means provided in a vehicle around vehicle 100 by transmitting a signal to the vehicle around the vehicle. Note that in the case where a past medical history or the like of a passenger is available as a passenger state as a result of subjecting the passenger to the personal identification, a notification pattern may be corrected for the passenger such as a visually-impaired person or a hearing-impaired person on the basis of an easily perceivable stimulus (an auditory stimulus for the visually-impaired person or a visual stimulus for the hearing-impaired person).

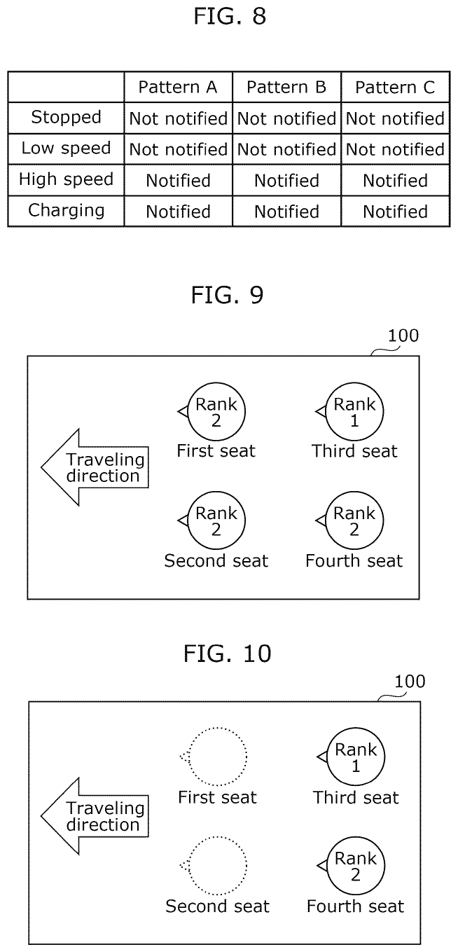

Meanwhile, with consideration given to the vehicle state, the notification modes are changed as illustrated in FIG. 8. FIG. 8 is a diagram illustrating another example of determining a notification mode according to the embodiment. As illustrated in FIG. 8, in the case where the vehicle state is “stopped” or “low speed traveling”, the impact of a cyber attack on powertrain ECU 317 described in the present embodiment is not significantly strong, and thus no notification is sent. That is, in this other example, in the case where the intrusion depth reaches the powertrain ECU, and the vehicle state is “high speed travelling” or “charging”, a plurality of notification means are sequentially used in a notification pattern according to one of the passenger states illustrated in FIG. 7. Note that the example of whether to send a notification illustrated in FIG. 8 illustrates a setting with consideration given to the characteristics of powertrain ECU 317. Thus, different settings may be used for different intrusion routes.

Referring back to FIG. 6, after the notifications to the passengers are mediated (step S18), a security notification is output to the devices that are provided in vehicle 100 and notify the passengers (step S19). The devices receive the output security notification and send notifications according to the security notification. In this manner, the notifications are sent such that the notifications conform to an appropriate notification mode.

Hereinafter, with reference to FIG. 9 to FIG. 15, variations will be described focusing on differences from the above-described embodiment. The descriptions and illustrations of the same points as in the embodiment will be omitted or simplified.

### Variation 1

FIG. 9 and FIG. 10 are diagrams for describing the notification ranks of passengers according to Variation 1 of the embodiment.

For example, in FIG. 9, four passengers are in vehicle 100 being a four-seater and have different passenger states. Specifically, a passenger sitting on a first seat has the passenger state “sleeping”, a passenger sitting on a second seat has the passenger state “sleeping”, a passenger sitting on a third seat has the passenger state “looking out a window”, and a passenger sitting on a fourth seat has the passenger state of “sleeping”. In this case, compared with the passengers sitting on the first, second, and fourth seats, the passenger sitting on the third seat can easily respond to an emergency because the passenger is awake. Thus, notification ranks are set such that the passenger sitting on the third seat is preferentially notified compared with the passengers sitting on the first, second, and fourth seats. As a result, as illustrated in the figure, the passengers sitting on the first, second, and fourth seats are in rank 2, and the passenger sitting on the third seat is in rank 1. As a result, the passenger in rank 1 is notified at first timing, and the passengers in rank 2 are subsequently notified at second timing. In this manner, in a notification at some timing (the first timing), it is possible to notify only a target passenger to be notified (the passenger sitting on the third seat) and not to notify the other passengers.

In FIG. 10, two passengers are in vehicle 100 being a four-seater and have different passenger states. Specifically, a passenger sitting on the third seat has the passenger state “watching”, and a passenger sitting on the fourth seat has the passenger state “looking out a window”. Since the passengers sitting on the third seat and the fourth seat are both awake, a notification rank is set under a more detailed rule. For example, it is assumed here that a notification with a display is sent. In this case, it is not possible to determine where the passenger sitting on the fourth seat who is “looking out the window” is actually looking. In contrast, it is clear that the passenger sitting on the third seat who is “watching” is watching in-vehicle equipment 31 used for the watching. Therefore, notification ranks are set such that the passenger sitting on the third seat is preferentially notified compared with the passenger sitting on the fourth seat.

Note that what passenger is to be preferentially notified in what situation (passenger state) depends on all possible external factors such as traffic regulations with which the moving body complies, the structure of the moving body, or simply the relationship among the passengers. Thus, the rule pertaining to the priority ranks may be capable of being set by a manager of notification device 10 or the like.

### Variation 2

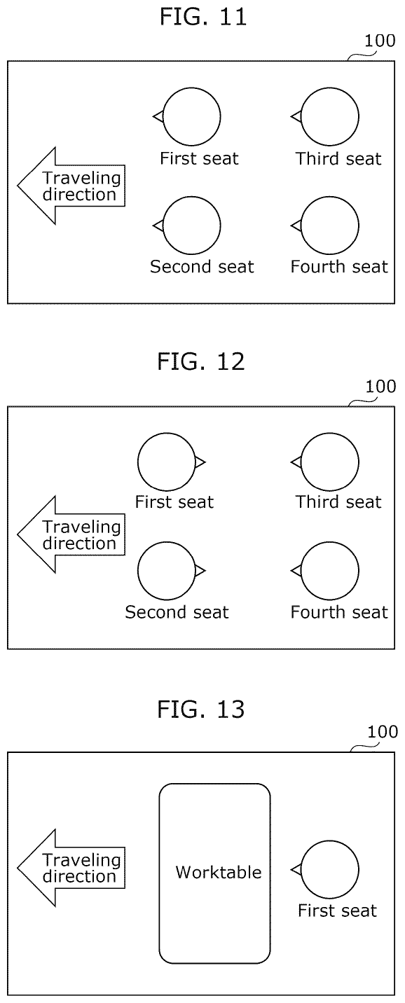

FIG. 11 to FIG. 13 are diagrams for describing a use mode of a passenger or passengers according to Variation 2 of the embodiment.

FIG. 11 to FIG. 13 illustrate situations in which passengers use vehicle 100 in different use modes. Specifically, FIG. 11 illustrates a use mode in which four seats facing in a traveling direction are placed as with a typical vehicle, and passengers are sitting with their front facing in the same traveling direction. In contrast, FIG. 12 illustrates a use mode in which two seats facing in the traveling direction and two seats opposing a traveling direction are placed face-to-face as in a small conference room, two of passengers sit with their front facing in the same traveling direction, and the other two passengers sit with their back facing in the traveling direction. FIG. 13 illustrates a use mode in which a seat for one person and a worktable are placed as with a private booth, and one passenger sits on the seat.

In this manner, a vehicle with autonomous movement on the verge of realization allows its inner space to be used more freely, and thus a more variety of passenger states based on a more variety of vehicle states are expected in the future. Therefore, setting notification modes (here, a notification pattern) under different rules for different use modes is highly likely to be appropriate.

Note that information on a use mode to be applied is obtained by, for example, inputting the use mode with a use mode setting button for specifying the use mode, using information on equipment or the like of vehicle 100 included in VIN information, or a switching operation associated with the use mode in the case of vehicle 100 in which the use modes can be switched.

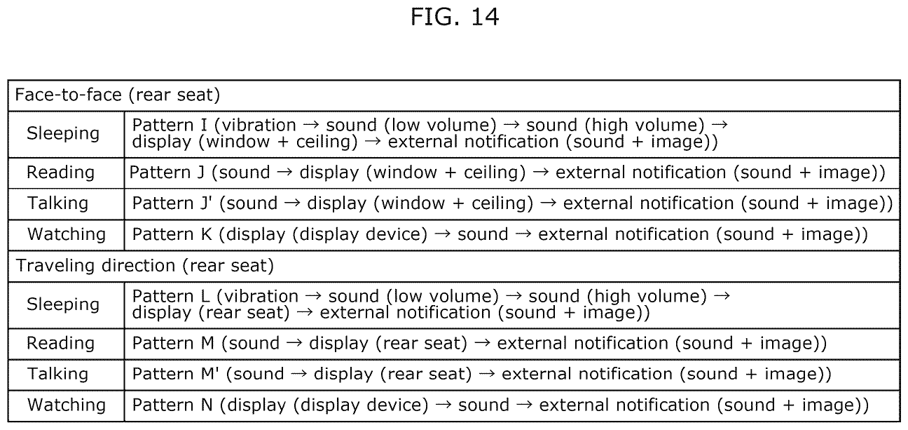

FIG. 14 is a diagram illustrating one example of determining a notification mode in each use mode according to Variation 2 of the embodiment. FIG. 14 exemplarily illustrates the case of the face-to-face use mode illustrated in FIG. 12 and the case of the traveling-direction use mode illustrated in FIG. 11, as one example of setting different notification modes to different use modes. As illustrated in the figure, different notification patterns are set to different use modes even in the same passenger state. In this manner, it is possible to determine a notification mode suitable for each use mode for appropriate notification.

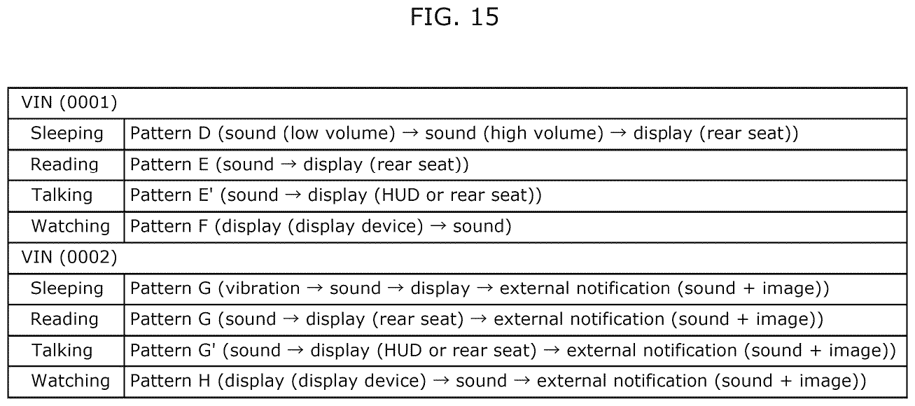

FIG. 15 is a diagram illustrating another example of determining a notification mode in each use mode according to Variation 2 of the embodiment. FIG. 15 exemplarily illustrates variations in notification mode based on the configuration of devices that are provided in vehicle 100 and notify passengers, for each of the VIN information items described with reference to FIG. 5. As illustrated in FIG. 15, for different configurations of devices that are provided in vehicle 100 and notify passengers, the notification pattern appropriately varies according to each of the configurations. Note that, also in the case of the notification modes exemplified in this variation, what passenger is to be preferentially notified or what notification means is preferentially used in what situation (passenger state) depends on all possible external factors such as traffic regulations with which the moving body complies, the structure of the moving body, or simply the relationship among the passengers. Thus, the rule pertaining to the order may be capable of being set by a manager of notification device 10 or the like.

### Other Embodiments

Although a notification device or the like according to an embodiment of the present disclosure have been described above, the present disclosure is not limited to the embodiment.

In the foregoing embodiment, constituent elements of the notification device may be configured by dedicated hardware or may be realized by executing software programs corresponding to those constituent elements. Each constituent element may be realized by a program executor such as a CPU or a processor reading out and executing a software program recorded onto a recording medium such as a hard disk or semiconductor memory.

Each constituent element may be a circuit (or an integrated circuit). These circuits may be included in a single circuit as a whole or may be separate circuits. Moreover, these circuits may be general purpose circuits or dedicated circuits.

General or specific aspects of the present disclosure may be realized by a system, a device, a method, an integrated circuit, a computer program, a computer-readable non-transitory recording medium such as a CD-ROM, or any combination thereof.

In the foregoing embodiment, a process executed by a specific processing unit may be executed by a different processing unit. An order of processes in the operation of the communication system described in the foregoing embodiment may be changed or processes may be executed in parallel.

While an embodiment has been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims is incorporated herein by reference in their entirety: Japanese Patent Application No. 2024-021516 filed on Feb. 15, 2024.

### Industrial Applicability

The present disclosure is useful for an appropriate notification to a passenger in a mobile body such as a vehicle.

1. A notification device comprising:
an intrusion depth obtainer that obtains an intrusion depth of a cyber attack on a moving body;
a passenger state obtainer that obtains a passenger state of a passenger in the moving body;
a mode determiner that determines a notification mode based on the intrusion depth obtained and the passenger state obtained; and
a notification controller that causes a security notification to be output, the security notification being for notifying, in accordance with the notification mode determined, the passenger that the cyber attack was made.

2. The notification device according to claim 1, wherein
the mode determiner causes the security notification to be output at timing when the intrusion depth reaches a predetermined depth.

3. The notification device according to claim 1, wherein
the mode determiner selects a notification means according to the passenger state from among a plurality of candidates for the notification means, and causes the notification means selected to output the security notification.

4. The notification device according to claim 1, further comprising:
a moving body state obtainer that obtains a moving body state of the moving body, wherein
the mode determiner determines the notification mode based also on the moving body state obtained.

5. The notification device according to claim 4, wherein
the moving body state includes at least one of whether the moving body is activated, a movement speed of the moving body, or whether the moving body is in an autonomous movement mode.

6. The notification device according to claim 4, wherein
the moving body state includes a use mode of the passenger who is using the moving body, and
the mode determiner determines the notification mode under a rule that is different depending on the use mode.

7. The notification device according to claim 4, wherein
the moving body state includes a configuration of a notification means provided in the moving body, and
the mode determiner determines, for each of notification means provided in the moving body, a notification order according to the passenger state, and causes each of the notification means to output the security notification in the notification order determined, each of the notification means being the notification means.

8. The notification device according to claim 1, wherein
one or more passengers are in the moving body, each of the one or more passengers being the passenger,
the notification mode includes specifying a target passenger to be notified among the one or more passengers, the target passenger being based on the passenger state, and
the notification controller causes the security notification to be output, the security notification notifying the target passenger and not notifying remaining passengers excluding the target passenger that the cyber attack was made.

9. A notification method to be executed by a computer, the notification method comprising:
obtaining an intrusion depth of a cyber attack on a moving body;
obtaining a passenger state of a passenger in the moving body;
determining a notification mode based on the intrusion depth obtained and the passenger state obtained; and
causing a security notification to be output, the security notification being for notifying, in accordance with the notification mode determined, the passenger that the cyber attack was made.

10. A non-transitory computer-readable recording medium for use in a computer, the recording medium having recorded thereon a computer program for causing the computer to execute the notification method according to claim 9.
